(19) United States
(12) Patent Application Publication
(10) Pub. No.: US 2011/0174956 A1
(43) Pub. Date: Jul. 21, 2011

(54) FORM AND METHOD AND APPARATUS FOR MAKING A FORM

(76) Inventor: Doug Smoljo, Milford Bay (CA)

(21) Appl. No.: 12/947,315

(22) Filed: Nov. 16, 2010

Related U.S. Application Data
(63) Continuation of application No. 11/779,143, filed on Jul. 17, 2007, now abandoned.
(60) Provisional application No. 60/831,226, filed on Jul. 17, 2006.

(51) Int. Cl. E04G 13/02; B31C 1/00; B32B 3/06

(52) U.S. Cl. 249/48; 493/299; 428/99

(57) ABSTRACT

A concrete form having a tubular body formed from a flexile strip wound helically in successive passes to define a wall of the form. The adjacent edges of the strip being releasably engaged with one another to inhibit axial separation of the strip.

### CROSS REFERENCE TO RELATED APPLICATIONS

This application is a continuation application of U.S. patent application Ser. No. 11/779,143 filed Jul. 17, 2007 which claims priority from U.S. Provisional Patent Application No. 60/831,226 filed on Jul. 17, 2006, the contents of which are incorporated herein by reference.

### FIELD OF THE INVENTION

The present invention relates to forms for moulding material and to methods and apparatus of creating such forms.

### SUMMARY OF THE INVENTION

Forms are used in a variety of applications to provide temporary containment for mouldable materials. A typical application of such form is in the pouring of concrete where it is necessary to hold the concrete in the desired shape until it has set. A commonly used form is a cylindrical tube that is used to establish pillars or piers to support additional structure. Typically, these tubes, commonly known by the trademark “Sonotube” are formed from layers of paper material that are helically wound and glued to one another during forming to produce a rigid structure. The tubes have sufficient strength to support concrete and, upon setting, the layers of the tube can be removed to expose the concrete.

Such tubes are widely used and are available from building supply stores in a variety of sizes. The sizes may range from 6 inches to 12 inches and the tubes are stored in a length that permits transportation, typically 20 feet. However, the storage of such tubes is difficult since they cannot be easily stacked one on top of the other due to their circular nature and is also in efficient as one tube occupies a large volume. Although some efficiency can be realized by nesting a smaller diameter tube within a larger one for transportation, this is impractical in the environment of a building supply store and also time consuming to pack the nested tubes.

There is therefore the need for a form that can offer efficiencies for storage and transportation without impairing the utility of the tube.

In general terms, the present invention provides a form that is helically wound from a flexible strip. The strip has a groove formed adjacent one edge and a complementary tongue formed on the opposite edge. The tongue and groove are dimensioned so as to be a snap fit to retain successive passes of the strip in forming a helical tube.

Preferably, the groove is undercut and the tongue has an enlarged head to enhance the retention within the groove. As a further preference, a locking key may be provided to expand the tongue after insertion and thereby enhance the retention of the tongue within the groove.

By providing a form of the structure described above, it is simply necessary to store rolls of strip that can then be deployed to form a cylinder of the required dimension and length.

In a further aspect of the invention, a forming machine is provided with an expandable mandrel to guide a strip in a helical path. A pinch roller is provided to force a tongue into an adjacent groove and as a further preference, a key strip may be pressed into the tongue subsequent to the pinch roller.

### BRIEF DESCRIPTION OF THE DRAWINGS

An embodiment of the invention will now be described by way of example only with reference to the accompanying drawings in which:

FIG. 1 is a perspective view of a cylindrical form.

FIG. 2 is a view on the line II of FIG. 1.

FIG. 3 is an enlarged view of a section of a strip used to form the tube shown in FIGS. 1 and 2.

FIG. 4 is a schematic representation of a machine to form the tube of FIG. 1.

FIG. 5 is a view similar to FIG. 2 of an alternative embodiment.

FIG. 6 is a view similar to FIG. 2 of two further embodiments.

### DETAILED DESCRIPTION OF THE INVENTION

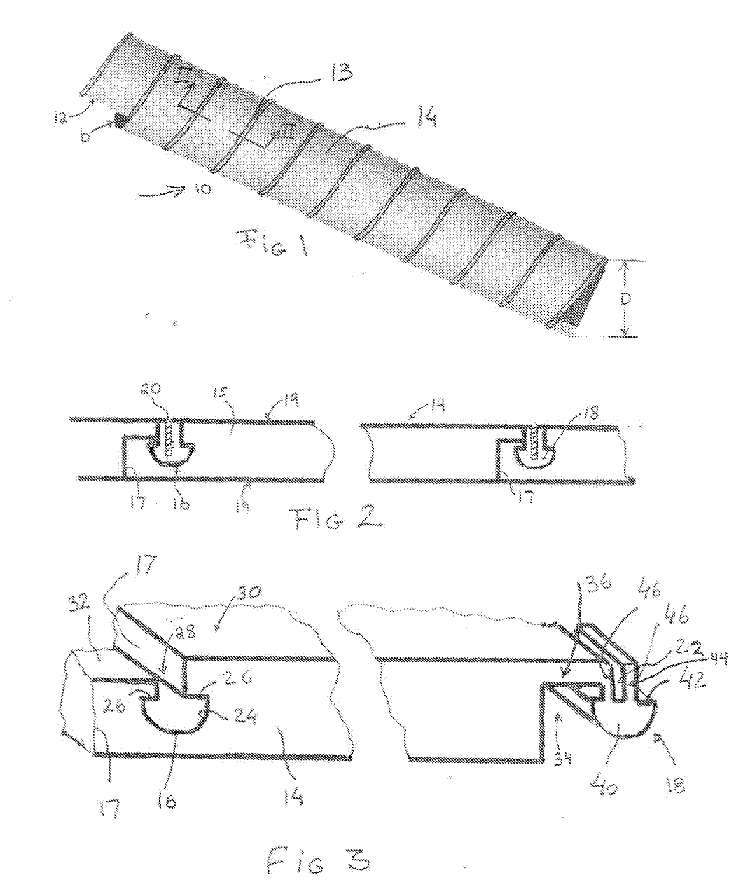

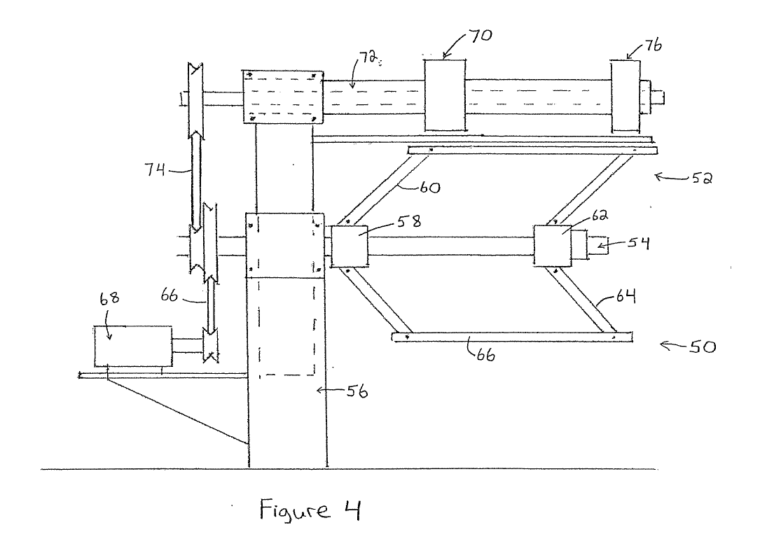

Referring therefore to FIG. 1, a form indicated by reference numeral 10 has a cylindrical wall 12 formed from a helically wound strip 14. Abutting edges of the strip 14 are interconnected by a tongue and groove joint generally indicated at 13 and seen in greater detail in FIGS. 2 and 3. The tube 10 is formed to a nominal diameter D which typically will range between 6 and 12 inches. The wall 14 has a nominal thickness indicated at b that is chosen so as to be sufficiently flexible to accommodate the radius of curvature required whilst withstanding the pressure that may be exerted when used as a form. A nominal thickness of ⅛″ is believed to be appropriate.

Referring therefore to FIG. 2, the strip 14 has a body 15 with lateral edges 17 and oppositely directed faces 19. Complementary formations in the form of a groove 16 and a tongue 18 are formed on opposite lateral edges 17. The strip 14 is preferably made from a plastics material which is flexible so as to be able to be formed into the smallest required diameter but also has sufficient strength to withstand the hydrostatic pressure of concrete placed within the tube.

As can be seen from FIG. 2, adjacent edges of the strip 14 are inter-engaged by the tongue 18 being inserted into the groove 16. As will be described in more detail below, the cross section of groove 16 has a re-entrant formation and the tongue 18 is of complementary cross section with an enlarged end such that a snap fit is obtained between the two to securely retain the tongue within the groove but allowing it to be removed subsequently. A locking key in the form of a strip 20 is inserted into a slot 22 formed in the tongue 18 to further secure the tongue within the groove.

Referring therefore to FIG. 3, the groove 16 has a part cylindrical base 24 that terminates at shoulders 26. The shoulders 26 extend in opposite directions from a channel 28 extending to an outer surface 30 of the strip 14. A rabbet is formed at the outer edge of the strip 14 so as to intersect the channel 28 and form a step 32 of a height less than the thickness of the strip 14.

The opposite edge of the strip 14 is undercut as indicated at 34 to provide a flange 36 that is complimentary to the step 32. The tongue 18 projects from the flange 36 and has a profile complementary to that of the groove 16. The tongue 18 has a part cylindrical head 40 terminating in abutment faces 42. A neck 44 of the tongue 18 connects the tongue to the flange 36 and has a pair of opposed walls 46 that define a slot 22.

To define a cylindrical tube 10 as shown in FIG. 1, the strip 14 is wound in a helical form so that the tongue 18 is aligned with the groove 16. The cylindrical head of the tongue permits it to be inserted into the channel 28 such that the abutment faces 42 engage the underside of the shoulders 26 and securely hold the tongue within the groove. In this position, by virtue of the provision of the step 32 and the flange 36, adjacent passes of the strip are aligned presenting a continuous smooth surface. The key 20 may then be inserted into the slot 22 to expand the neck 44 within the channel 28 and further secure the tongue 18 within the groove 16.

With a cylindrical tube defined, it may be used as a form with, for example, concrete, to hold the concrete until it is solidified. Upon setting of the concrete, the key 20 is removed and strip 14 may then be unwound by pulling the tongue 18 out of the groove 16. This will proceed in a smooth progressive manner along the length of the strip to release the tube from the outer surface of the cured concrete.

It will be apparent from the above description that the strip 14 may be stored in rolls of sufficient length provided to permit a tube of the required diameter and length to be formed. The diameter through which the strip is wound may be varied to provide tubes of different length.

To facilitate the formation of the tube 10, a winding apparatus as shown schematically in FIG. 4 may be used.

Referring therefore to FIG. 4, a forming machine 50 has an unexpandable mandrill 52 about which the strip 14 may be rolled. The mandrill 52 is mounted upon a shaft 54 which in turn is rotatably mounted upon a support 56. A spider assembly 58 is fixed to the shaft 54 adjacent the support 56 and carries four arms 60 that are pivotally connected to the spider 58. A slidable spider 62 is mounted on the opposite end of the shaft 54 and similarly carries arm 64. Support bars 66 extend between the outer ends of the arms 64 to define the mandrill 52. The spiders 58, 62 are mounted on splines provided on the shaft 54 so that they may rotate their width. However, the slide at the spider 62 is axially displaceable along the shaft to define the outer diameter of the mandrill 52.

The shaft 54 is driven through a belt drive 66 from an electric motor 68 that is mounted on the support 56. The support 56 also carries a nip roller 70 that is mounted upon a shaft 72. The shaft 72 is rotatably mounted on the support 56 and driven through a belt drive 74 from the motor 68. The nip roller is adjustable relative to the shaft 54 so that it may be positioned adjacent to but spaced from the bars 66.

To form a tube 10, strip 4 shown in ghosted outline of FIG. 4 is fed at an angle onto the mandrill 52 between the nip roller and the outer surface of the bars 66. The nip roller 70 progressively forces the tongue 18 into the groove 16 as the mandrill is rotated to provide a continuous forming of the tube 10 that projects axially from the mandrill. After the desired length of tube has been formed, the strip may be cut and the ends of tube trimmed square for subsequent use.

Where a key is inserted into the slot 22, an additional roller 76 is spaced from the nip roller 70 and the key fed into the slot 60 and forced into the slot 22 by the action of the roller 76.

It will be appreciated that the formation of the tube 12 may be conducted at a building supply outlet or can be delivered as a strip on site where the tube can then be formed of the required diameter.

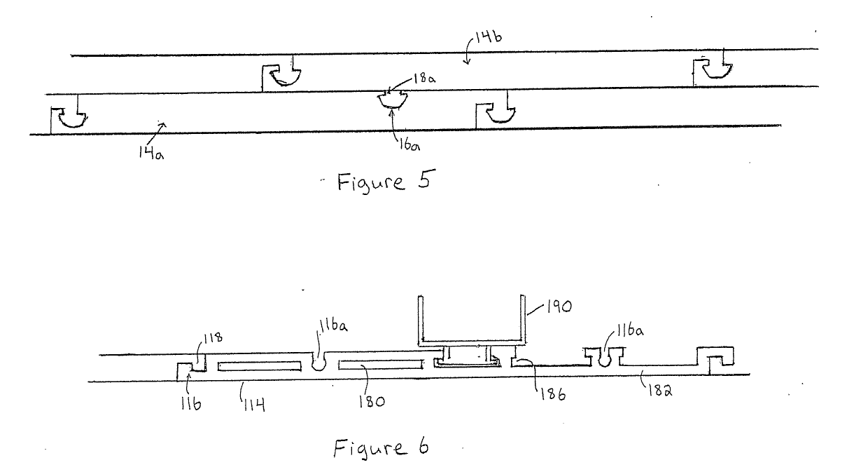

Reinforcement of the tube 10 may be provided by forming multiple layers on the tube. Such an arrangement is shown in FIG. 5 where a first layer of the wall 12 is formed as described above. In this arrangement, the strip 14a is formed with a groove 16a intermediate the lateral edges of the strip 14a. The groove receives a tongue 18a projecting from the underside of a further strip 14b. The strip 14b is formed with the inter-engaging formation at opposite lateral edges but has the additional tongue 18a for engagement with a radially inner wall.

A further embodiment is shown in FIG. 6 in which like reference numerals will be denoted by like components with a prefix 1 for clarity. Referring therefore to FIG. 6, the strip 114 is formed with a grove 116a intermediate the lateral edges of the strip 114. The groove 116a is arranged to receive a tongue carried on the underside of an additional strip arranged radially as shown with respect to FIG. 5. The laterally outer edges of the strip 114 are formed with a groove 116 and tongue 118 that are simple hook members and do not provide a re-entrant formation. The groove 116 and tongue 118 inhibits axial separation of adjacent passes at the strip but radial locking of the strip is provided by the inter-engagement of the re-entrant intermediate groove 116a and the corresponding tongue carried by the adjacent layer.

It will also be observed in FIG. 6 that the strip 114 is formed with hollow cells 180 defined between a pair of webs 182, 184. The cells 180 may be formed during extrusion of the strip in a conventional manner. The provision of the cells 180 decreases the weight of the strip whilst maintaining the structural integrity.

As a further alternative as shown on the right hand side of FIG. 6, the strip may be formed with a single web 182 with the groove 116a upstanding from the web 182. Flanges 186 are provided intermediate grooves 116a so as to provide a re-entrant channel on one side of the web 182. The flanges provide the necessary radial stiffness but also facilitate the attachment of support brackets 190 that may be snapped into the re-entrant channel at discrete locations. In the embodiment shown in FIG. 6, the bracket 190 is arranged to receive a standard dimensional lumber brace, typically a two by four, so that the brace may be secured to the tube to assist in maintaining it in its desired location during pouring of the concrete. The brackets 190 may be attached at a number of different locations about the circumference of the tube and at different axial positions along the tube.

It will be seen therefore that a simple yet effective tube is provided which may be assembled from strip to facilitate storage of the material. Assembly of the tube from the strip is relatively straightforward and permits the tube to be made to the desired length and diameter to suit particular circumstances. The tube may be formed with multiple layers and the strip may have different configurations to facilitate manufacturer.

1. A concrete form having a tubular body formed from a flexile strip wound helically in successive passes to define a wall of said form, adjacent edges of said strip being releasably engaged with one another to inhibit axial separation of said strip.

2. A concrete form according to claim 1 wherein said adjacent edges are inter-engaged by a groove formed on one edge of said strip and a tongue formed on an opposite edge of said strip.

3. A concrete form according to claim 2 wherein said tongue and groove have complementary re-entrant formations to inhibit radial separation of said tongue from said groove.

4. A form according to claim 2 wherein a locking spline is inserted into said tongue to inhibit axial separation of said tongue and said groove.

5. A form according to claim 4 wherein said tongue and groove have complementary re-entrant formations to inhibit radial separation of said tongue from said groove.

6. A form according to claim 1 wherein a groove is provided intermediate said edges to receive a tongue projecting from an adjacent overlying strip.

7. A form according to claim 1 wherein an open channel is provided on an external surface of said strip to receive a bracket.

8. A form according to claim 1 wherein said strip is formed from a plastics material.

9. A form according to claim 8 wherein said strip has hollow cells formed therein between external walls of said strip.

10. A form according to claim 9 wherein said tongue and groove have complementary re-entrant formations to inhibit separation of adjacent edges of said strip.

11. A method of forming tubular form from a strip of material having tongue and a groove formed on one edge and a tongue formed on an opposite edge, said method comprising the steps of helically winding said strip to bring adjacent edges into abutment and engaging said tongue with said groove to inhibit axial separation of adjacent edges.

12. A method according to claim 11 including the step of inserting a locking spline into said tongue.

13. A method according to claim 11 including the step of juxtaposing a pair of strips to provide a pair of layers and inter-engaging said layers to inhibit radial separation.

14. A strip for use in forming a tubular form, said strip having a body of flexible material, a tongue formed on one edge of said body, a groove on an opposite edge of said body, said tongue and groove having complementary cross sections to permit inter-engagement of said tongue and groove to inhibit axial separation.

15. A strip according to claim 14 wherein said tongue and groove have complementary re-entrant formations.

16. A strip according to claim 14 wherein said tongue has a slot to receive a locking spline.

17. A strip according to claim 16 wherein said tongue and groove have complementary re-entrant formations.

18. A strip according to claim 11 including an auxiliary groove foamed intermediate said edges or one surface of said body.

19. A strip according to claim 18 wherein said auxiliary groove has a re-entrant formation.

20. A strip according to claim 11 including an auxiliary tongue projecting from said body intermediate said edges.

21. A strip according to claim 20 wherein said auxiliary tongue has a re-entrant formation.
